(19) United States
(12) Patent Application Publication
(10) Pub. No.: US 2024/0344473 A1
(43) Pub. Date: Oct. 17, 2024

(54) PARTICULATE FILTER HAVING PARTIALLY COATED CATALYTIC LAYER

(71) Applicant: BASF CORPORATION, Florham Park, NJ (US)

(72) Inventors: Inga ELLMERS, Hannover (DE); Florian WALTZ, Hannover (DE); Juncong JIANG, Beijing (CN); Attilio SIANI, Hannover (DE); Stephan SIEMUND, Hannover (DE); Thomas SCHMITZ, Hannover (DE)

(21) Appl. No.: 18/682,744

(22) PCT Filed: Aug. 10, 2022
(86) PCT No.: PCT/CN2022/111444

§ 371 Date: Feb. 9, 2024

(30) Foreign Application Priority Data
Aug. 11, 2021 (WO) PCT/CN2021/112033

(51) Int. Cl. F01N 3/035; B01D 53/94

(52) U.S. Cl. CPC F01N 3/035; B01D 53/945; B01D 53/9468; B01D 2255/102; B01D 2255/9022; B01D 2255/915; B01D 2258/01

(57) ABSTRACT

A catalyzed particulate filter for exhaust gas from an internal combustion engine, comprising: a particulate filter of total length L; a first catalytic layer coated onto the particulate filter, comprising a first composition, wherein the first composition comprising a first support material; and a first platinum group metal and/or a first catalytic active transitional metal; a second catalytic layer coated onto the particulate filter, comprising a second composition, wherein the second composition comprises a second support material; and said first catalytic layer is present on a portion of said particulate filter, and extends from either upstream or downstream end in axial direction of said particulate filter for a length L1, and L1 is in the range from 20 to 90% of L.

### TECHNOLOGY FIELD

The present invention relates to a catalyzed particulate filter having partially coated catalytic layer for the treatment of exhaust gas from an internal combustion engine, relates to a process for preparing the catalyzed particulate filter and relates to a method for the treatment of exhaust gas from an internal combustion engine.

### BACKGROUND

The exhaust gas from internal combustion engine contains in relatively large part of nitrogen, water vapor, and carbon dioxide; but the exhaust gas also contains in relatively small part of noxious and/or toxic substances, such as carbon monoxide from incomplete combustion, hydrocarbons from un-burnt fuel, nitrogen oxides (NOx) from excessive combustion temperatures, and particulate matter (PM).

Certain internal combustion engines, for example lean-burn engines, diesel engines, natural gas engines, power plants, incinerators, and gasoline engines, tend to produce an exhaust gas with a considerable amount of soot and other particulate matter. Usually, particulate matter emissions can be remedied by passing the PM-containing exhaust gas through a particulate filter.

On Dec. 23, 2016, the Ministry of Environmental Protection (MEP) of the People's Republic of China published the final legislation for the China 6 limits and measurement methods for emissions from light-duty vehicles (GB18352.6-2016; hereafter referred to as China 6), which is much stricter than the China 5 emission standard. Especially, China 6b incorporates limits on particulate matter (PM) and adopts the on-board diagnostic (OBD) requirements. Furthermore, it is implemented that vehicles should be tested under World Harmonized Light-duty Vehicle Test Cycle (WLTC). WLTC includes many steep accelerations and prolonged high-speed requirements, which demand high power output that could have caused “open-loop” situation (as fuel paddle needs to be pushed all the way down) at extended time (e.g., >5 sec) under rich (lambda<1) or under deep rich (lambda<0.8) conditions.

As particulate standards become more stringent, there is a need to provide an improved particulate filter having excellent filtration efficiency and low backpressure.

### SUMMARY OF THE INVENTION

It is an object of the present invention to provide a catalyzed particulate filter for exhaust gas from an internal combustion engine comprising:
a particulate filter (PF) of total length L;
a first catalytic layer coated onto the particulate filter, comprising a first composition, wherein the first composition comprising a first support material; and a first platinum group metal (PGM) and/or a first catalytic active transitional metal;
a second catalytic layer coated onto the particulate filter, comprising a second composition, wherein the second composition comprising a second support material; and
said first catalytic layer is present on a portion of said PF, and extends from either upstream or downstream end in axial direction of said PF for a length (L1), and L1 is in the range from 20 to 90% of L.

Another object of the present invention is to provide a process for preparing the catalyzed particulate filter for the treatment of exhaust gas from an internal combustion engine.

A further object of the present invention is to provide a method for the treatment of exhaust gas from an internal combustion engine, which comprises flowing the exhaust gas from the engine through the catalyzed particulate filter according to the present invention.

It has been surprisingly found that the above objects can be achieved by following embodiments:
1. A catalyzed particulate filter for exhaust gas from an internal combustion engine comprising:
   a particulate filter (PF) of total length L;
   a first catalytic layer coated onto the particulate filter, comprising a first composition, wherein the first composition comprising a first support material; and a first platinum group metal (PGM) and/or a first catalytic active transitional metal;
   a second catalytic layer coated onto the particulate filter, comprising a second composition, wherein the second composition comprises a second support material; and
   said first catalytic layer is present on a portion of said PF, and extends from either upstream or downstream end in axial direction of said PF for a length (L1), and L1 is in the range from 20 to 90% of L.
2. The catalyzed particulate filter according to item 1, wherein L1 is in the range from 25% to 85% of L, preferably from 28% to 80% of L.
3. The catalyzed particulate filter according to item 1 or 2, wherein the ratio of the weight of the first catalytic layer to the volume of the portion of the PF coated with the first catalytic layer is in the range from 10 to 160 g/L, preferably from 15 to 150 g/L or from 20 to 120 g/L.
4. The catalyzed particulate filter according to any of items 1 to 3, wherein the ratio of the weight of the first catalytic layer to the total volume of the PF is in the range from 10 to 120 g/L, preferably from 20 to 100 g/L.
5. The catalyzed particulate filter according to any of items 1 to 4, wherein the first support material comprises at least one refractory metal oxide.
6. The catalyzed particulate filter according to any of items 1 to 5, wherein the first catalytic layer is a washcoat.
7. The catalyzed particulate filter according to any of items 1 to 6, wherein the first catalytic active transitional metal is selected from Cu, Fe, Co, Ni, La, Ce, Ag or Mn, or any combination thereof, preferably selected from Ce, Mn, Cu or Fe, or any combination thereof.
8. The catalyzed particulate filter according to any of items 1 to 7, wherein the second support material comprises at least one inorganic material, preferably, the inorganic material is selected from inorganic oxide and inorganic salt.
9. The catalyzed particulate filter according to any of items 1 to 8, wherein the second composition is in the form of particulate, preferably the second composition has a D90 of 0.1 to 50 μm, preferably 1 to 20 μm, and more preferably a D90 of 3 to 10 μm.
10. The catalyzed particulate filter according to any of items 1 to 9, wherein the ratio of the weight of the second catalytic layer to the total volume of the PF is in the range from 0.5 to 20 g/L, preferably from 0.6 to 15 g/L, more preferably from 0.7 to 12 g/L.
11. The catalyzed particulate filter according to any of items 1 to 10, wherein the second catalytic layer is present on the whole length L of the PF.
12. The catalyzed particulate filter according to any of items 1 to 11, wherein said first catalytic layer extends from upstream end of the PF.
13. The catalyzed particulate filter according to any of items 1 to 11, wherein said first catalytic layer extends from downstream end of the PF.
14. A process for preparing the catalyzed particulate filter according to any of items 1 to 13, comprises:
i) providing a filter substrate of total length L;
ii) coating the filter substrate with a slurry containing the first composition from either the upstream end or the downstream end of the particulate filter; and
iii) further coating the filter substrate obtained in step ii) with the second composition;
wherein the length (L1) of the portion of the filter substrate coated with the first composition is in the range from 20 to 90% of L.
15. The process according to item 14, wherein step (iii) is carried out by coating the filter substrate obtained in step (ii) with the second composition in a particulate form via a gas carrier through one side of the filter substrate.
16. The process according to item 14 or 15, wherein step (ii) further comprises calcinating the coated filter substrate after coating.
17. A method for the treatment of exhaust gas from an internal combustion engine, which comprises flowing the exhaust gas from the engine through the catalyzed particulate filter according to any one of items 1 to 13.
18. The method according to item 17, wherein the exhaust gas comprises unburned hydrocarbons, carbon monoxide, nitrogen oxides, and particulate matter.

The catalyzed particulate filter of the present invention can obtain better filtration efficiency without increasing backpressure, and/or produce lower backpressure without reducing the filtration efficiency and/or use less amount of second catalytic layer without reducing the filtration efficiency or increasing backpressure.

### DESCRIPTION OF THE DRAWING

FIG. 1 shows a plot of backpressure for catalyzed particulate filters prepared in example 1 and example 2 at fresh state.

FIG. 2 shows a plot of filtration efficiency for catalyzed particulate filters prepared in example 1 and example 2 at fresh state.

FIG. 3 shows a plot of backpressure for catalyzed particulate filters prepared in examples 3, 4, 5 and 6 at fresh state.

FIG. 4 shows a plot of filtration efficiency for catalyzed particulate filters prepared in examples 3, 4, 5 and 6 at fresh state.

FIG. 5 shows a plot of backpressure for catalyzed particulate filters prepared in examples 7, 8, 9 and 10 at fresh state.

FIG. 6 shows a plot of filtration efficiency for catalyzed particulate filters prepared in examples 7, 8, 9 and 10 at fresh state.

FIG. 7(a) and FIG. 7(b) show an exemplary wall-flow filter.

### EMBODIMENT OF THE INVENTION

The following abbreviations have been used:
“HC”=hydrocarbon;
“NOx”=nitrogen oxides;
“CO”=carbon monoxide;
“WLTC”=World Harmonized Light-duty Vehicle Test Cycle;
“PM”=particulate matter;
“CCC”=close-coupled catalyst;
“UFC”=underfloor catalyst;
“OSC”=oxygen storage component;
“PGM”=platinum group metal;
“WFF”=wall-flow filter;
“SCR catalyst”=selective catalytic reduction catalyst;
“DOC”=diesel oxidation catalyst;
“DEC”=Diesel Exotherm catalyst;
“TWC catalyst”=Three-way conversion catalyst.

The undefined article “a”, “an”, “the” means one or more of the species designated by the term following said article.

In the context of the present disclosure, any specific values mentioned for a feature (comprising the specific values mentioned in a range as the end point) can be recombined to form a new range.

In the context of the present disclosure, each aspect so defined may be combined with any other aspect or aspects unless clearly indicated to the contrary. In particular, any feature indicated as being preferred or advantageous may be combined with any other feature or features indicated as being preferred or advantageous.

As used herein, the term “catalyst” or “catalyst composition” refers to a material that promotes a reaction.

As used herein, the terms “upstream” and “downstream” refer to relative directions according to the flow of an engine exhaust gas stream from an engine towards a tailpipe, with the engine in an upstream location and the tailpipe and any pollution abatement articles such as filters being downstream from the engine.

The terms “exhaust gas”, “exhaust stream,” “engine exhaust stream, “exhaust gas stream” and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically further comprises combustion products, hydrocarbon, products of incomplete combustion, oxides of nitrogen, combustible and/or carbonaceous particulate matter (soot) and un-reacted oxygen and/or nitrogen.

As used herein, the term “washcoat” has its usual meaning in the art of a thin, adherent coating of a catalytic or other material applied to a substrate material.

A washcoat is formed by preparing a slurry containing a certain solid content (e.g., 10-90% by weight or 30-90% by weight) of particles in a liquid medium, which is then coated onto a substrate and dried to provide a washcoat layer.

The catalyst may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst is not new and has been exposed to exhaust gases and/or elevated temperature (i.e., greater than 500° C.) for a prolonged period of time (i.e., greater than 3 hours).

A “support” in a catalytic material or catalyst washcoat refers to a material that receives metals (e.g., PGMs), stabilizers, promoters, binders, and the like through precipitation, association, dispersion, impregnation, or other suitable methods. Exemplary supports include refractory metal oxide supports as described herein below.

“Refractory metal oxide supports” are metal oxides including, for example, alumina, silica, titania, ceria, and zirconia, magnesia, barium oxide, manganese oxide, tungsten oxide, and rear earth metal oxide rear earth metal oxide, base metal oxides, as well as physical mixtures, chemical combinations and/or atomically-doped combinations there-of and including high surface area or activated compounds such as activated alumina. Exemplary combinations of metal oxides include alumina-zirconia, alumina-ceria-zirconia, lanthana-alumina, lanthana-zirconia-alumina, baria-alumina, baria-lanthana-alumina, baria-lanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina. Such materials are generally considered as providing durability to the resulting catalyst.

“High surface area refractory metal oxide supports” refer specifically to support particles having pores larger than 20 Å and a wide pore distribution. High surface area refractory metal oxide supports, e.g., alumina support materials, also referred to as “gamma alumina” or “activated alumina,” typically exhibit a BET surface area of fresh material in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases.

The term “NOx” refers to nitrogen oxide compounds, such as NO or NO₂.

As used herein, the term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof. In one embodiment, the oxygen storage component comprises a ceria-zirconia composite or a rare earth-stabilized ceria-zirconia.

A platinum group metal (PGM) component refers to any component that includes a PGM (Ru, Rh, Os, Ir, Pd, Pt and/or Au). For example, the PGM may be in metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

One aspect of the present invention is directed to a catalyzed particulate filter for exhaust gas from an internal combustion engine comprising:
a particulate filter (PF) of total length L;
a first catalytic layer coated onto the particulate filter, comprising a first composition, wherein the first composition comprising a first support material; and a first platinum group metal (PGM) and/or a first catalytic active transitional metal;
a second catalytic layer coated onto the particulate filter, comprising a second composition, wherein the second composition comprises a second support material; and
   said first catalytic layer is present on a portion of said PF, and extends from either upstream or downstream end in axial direction of said PF for a length (L1), and L1 is in the range from 20 to 90% of L.

### Particulate Filter

The particulate filter is typically formed of a porous substrate. The porous substrate may comprise a ceramic material such as, for example, cordierite, silicon carbide, silicon nitride, zirconia, mullite, spodumene, alumina-silica-magnesia, zirconium silicate, and/or aluminium titanate, typically cordierite or silicon carbide. The porous substrate may be a porous substrate of the type typically used in emission treatment systems of internal combustion engines.

The internal combustion engine may be a lean-burn engine, a diesel engine, a natural gas engine, a power plant, an incinerator, or a gasoline engine.

The porous substrate may exhibit a conventional honey-comb structure. The filter may take the form of a conventional “through-flow filter”. Alternatively, the filter may take the form of a conventional “wall-flow filter” (WFF). Such filters are known in the art.

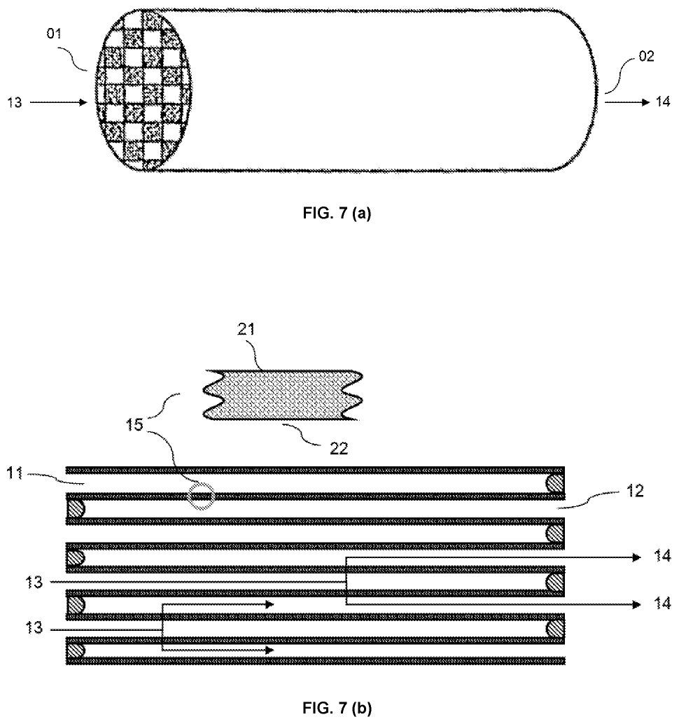

The particulate filter is preferably a wall-flow filter. Referring to FIG. 7(a) and FIG. 7(b), an exemplary wall-flow filter is provided. Wall-flow filters work by forcing a flow of exhaust gases (13) (including particulate matter) to pass through walls formed of a porous material.

A wall-flow filter typically has a first face and a second face defining a longitudinal direction therebetween. In use, one of the first face and the second face will be the inlet face (upstream end) for exhaust gases (13) and the other will be the outlet face (downstream end) for the treated exhaust gases (14). A conventional wall-flow filter has first and second pluralities of channels extending in the longitudinal direction. The first plurality of channels (11) is open at the inlet face (01) and closed at the outlet face (02). The second plurality of channels (12) is open at the outlet face (02) and closed at the inlet face (01). The channels are preferably parallel to each other to provide a constant wall thickness between the channels. As a result, gases entering one of the plurality of channels from the inlet face cannot leave the monolith without diffusing through the channel walls (15) from the inlet side (21) to the outlet side (22) of the channel walls into the other plurality of channels. The channels are closed with the introduction of a sealant material into the open end of a channel. Preferably the number of channels in the first plurality is equal to the number of channels in the second plurality, and each plurality is evenly distributed throughout the monolith. Preferably, within a plane orthogonal to the longitudinal direction, the wall-flow filter has from 100 to 500 channels per square inch, preferably from 200 to 400. For example, on the inlet face (01), the density of open channels and closed channels is from 200 to 400 channels per square inch. The channels can have cross sections that are rectangular, square, circular, oval, triangular, hexagonal, or other polygonal shapes.

### The First Catalytic Layer

According to the present invention, the first catalytic layer extends either from the upstream end or from downstream end of the particulate filter.

The length (L1) of the portion of PF coated with the first catalytic can be in the range from 20 to 90% of the total length (L) of the particulate filter, preferably in the range from 25% to 85% of total length L, for example, L1 can be 25%, 30%, 40%, 50%, 60%, 70%, 80%, 85%, or 90% of total length L, preferably from 28% to 80% or from 30% to 78% or from 40% to 60% of total length L.

In an embodiment, the ratio of the weight of the first catalytic layer to the volume of the portion of the PF coated with the first catalytic layer is in the range from 10 to 160 g/L, for example 10 g/L, 20 g/L, 30 g/L, 40 g/L, 50 g/L, 60 g/L, 80 g/L, 100 g/L, 120 g/L, 140 g/L or 160 g/L, preferably from 15 to 150 g/L, or from 20 to 150 g/L, or from 30 to 150 g/L, or from 40 to 150 g/L, or from 55 to 145 g/L, from 20 to 120 g/L, or from 30 to 120 g/L, or from 40 to 120 g/L, or from 55 to 120 g/L, or from 20 to 100 g/L, or from 30 to 100 g/L, or from 40 to 100 g/L.

Regarding the volume of the portion of the PF coated with the first catalytic layer, taking a particulate filter in the form of a cylinder with a radius of R and a height of H as an example, if L1 is 50% of L, the volume of the portion of the PF coated with the first catalytic layer can be calculated as follows: πR²×H×0.5.

In an embodiment, the ratio of the weight of the first catalytic layer to the total volume of the PF can be in the range from 10 to 120 g/L, for example 10 g/L, 20 g/L, 30 g/L, 40 g/L, 50 g/L, 60 g/L, 70 g/L, 80 g/L, 90 g/L, or 100 g/L, preferably from 20 to 100 g/L or from 30 to 90 g/L or from 35 to 75 g/L.

According to the present invention, the first catalytic layer comprises a first composition, and the first composition comprises a first support material; and a first platinum group metal (PGM) and/or a first catalytic active transitional metal.

The first platinum group metal (PGM) can be selected from Ru, Rh, Os, Ir, Pd, Pt and Au. In a preferred embodiment, PGM is selected from Pt, Rh and Pd.

The ratio of the weight of the first PGM in the first catalytic layer to the volume of the portion of the PF coated with the first catalytic layer can be in the range from 0.1 to 3 g/L, for example 0.1 g/L, 0.12 g/L, 0.15 g/L, 0.18 g/L, 0.2 g/L, 0.25 g/L, 0.3 g/L, 0.5 g/L, 0.8 g/L, 1.0 g/L, 1.5 g/L, 2 g/L, 2.5 g/L or 3 g/L, preferably from 0.15 to 2.5 g/L, or from 0.18 to 2.2 g/L.

The ratio of the weight of the first PGM in the first catalytic layer to the total volume of PF can be in the range from 0.07 to 1.8 g/L, for example 0.08 g/L, 0.09 g/L, 0.1 g/L, 0.12 g/L, 0.15 g/L, 0.18 g/L, 0.2 g/L, 0.25 g/L, 0.3 g/L, 0.5 g/L, 0.8 g/L, 1 g/L, 1.2 g/L, 1.5 g/L, 1.6 g/L or 1.8 g/L, preferably from 0.1 to 1.5 g/L or from 0.15 to 1.2 g/L.

The first catalytic active transitional metal can be selected from Cu, Fe, Co, Ni, La, Ce, Ag or Mn, or any combination thereof, preferably selected from Ce, Mn, Cu or Fe, or any combination thereof.

The ratio of the weight of the first catalytic active transitional metal in the first catalytic layer to the volume of the portion of the PF coated with the first catalytic layer can be in the range from 1.5 to 18 g/L, for example 1.0 g/L, 1.5 g/L, 2 g/L, 2.5 g/L, 3 g/L, 4 g/L, 5 g/L, 6 g/L, 8 g/L, 10 g/L, 12 g/L, 14 g/L, 16 g/L or 18 g/L, preferably from 2 to 15 g/L.

The ratio of the weight of the first catalytic active transitional metal in the first catalytic layer to the total volume of PF can be in the range from 1 to 15 g/L, for example 1.0 g/L, 1.5 g/L, 2 g/L, 2.5 g/L, 3 g/L, 4 g/L, 5 g/L, 6 g/L, 8 g/L, 10 g/L, 12 g/L, 14 g/L or 15 g/L, preferably from 1.5 to 10 g/L.

According to the present invention, said first catalytic layer is present on a portion of said PF, and extends from either upstream or downstream end in axial direction of said PF for a length (L1). According to the present invention, the remaining part is substantially free of a layer comprising the first composition. As used herein, “substantially free of a layer comprising the first composition” means the ratio of the weight of the layer comprising the first composition in the remaining part to the volume of the remaining part of the particulate filter is less than 5 g/L, preferably less than 3 g/L, more preferably less than 2 g/L or less than 1 g/L or less than 0.5 g/L or less than 0.1 g/L.

According to the present invention, the first composition comprises a first support material. Preferably, the first support material comprises at least one refractory metal oxide.

The refractory metal oxide can be used as the support of the PGM and/or the catalytic active transitional metal. The details of the refractory metal oxide can refer to the above description for “Refractory metal oxide supports”. In an embodiment, refractory metal oxide is selected from the group consisting of alumina, zirconia, silica, titania, and combinations thereof.

In a preferred embodiment, the first composition can further comprise at least one oxygen storage component (OSC). The details of the OSC can refer to the above description for “oxygen storage component”.

In a preferred embodiment, the first composition can further comprise at least one dopant. As used herein, the term “dopant” referring to a component that is intentionally added to enhance the activity of the first composition as compared to a first composition that does not have a dopant intentionally added. In the present disclosure, exemplary dopants are oxides of metals such as lanthanum, neodymium, praseodymium, yttrium, barium, cerium, niobium and combinations thereof.

The first composition may further comprise one or more of a selective catalytic reduction (SCR) catalyst, a diesel oxidation catalyst (DOC), an AMOx catalyst, a NOx trap, a NOx absorber catalyst.

As used herein, the terms of “selective catalytic reduction” and “SCR” refer to the catalytic process of reducing oxides of nitrogen to nitrogen (N2) using a nitrogenous reductant. The SCR catalyst may include at least one material selected front: MOR; USY; ZSM-5; ZSM-20; beta-zeolite; CHA; LEV; AEI; AFX; FER; SAPO; ALPO; vanadium; vanadium oxide; titanium oxide; tungsten oxide; molybdenum oxide; cerium oxide; zirconium oxide; niobium oxide; iron; iron oxide; manganese oxide; copper; molybdenum; tungsten; and mixtures thereof. The support structures for the active components of the SCR catalyst may include any suitable zeolite, zeo-type, or non-zeolitic compound. Alternatively, the SCR catalyst may include a metal, a metal oxide, or a mixed oxide as the active component. Transition metal loaded zeolites (e.g., copper-chabazite, or Cu-CHA, as well as copper-levyne, or Cu-LEV, as well as Fe-Beta) and zeo-types (e.g., copper-SAPO, or Cu-SAPO) are preferred.

As used herein, the terms of “diesel oxidation catalyst” and “DOC” refer to diesel oxidation catalysts, which are well-known in the art. Diesel oxidation catalysts are designed to oxidize CO to CO₂ and gas phase HC and an organic fraction of diesel particulates (soluble organic fraction) to CO₂ and H₂O. Typical diesel oxidation catalysts include platinum and optionally also palladium on a high surface area inorganic oxide support, such as alumina, silica-alumina, titania, silica-titania, and a zeolite. As used herein, the term includes a DEC (Diesel Exotherm Catalyst) with creates an exotherm.

As used herein, the terms of “ammonia oxidation catalyst” and “AMOx” refer to catalysts comprise at least a supported precious metal component, such as one or more platinum group metals (PGMs), which is effective to remove ammonia from an exhaust gas stream. In specific embodiments, the precious metal may include platinum, palladium, rhodium, ruthenium, iridium, silver or gold. In specific embodiments, the precious metal component includes physical mixtures or chemical or atomically-doped combinations of precious metals.

The precious metal component is typically deposited on a high surface area refractory metal oxide support. Examples of suitable high surface area Refractory Metal Oxides include alumina, silica, titania, ceria, and zirconia, magnesia, barium oxide, manganese oxide, tungsten oxide, and rear earth metal oxide, base metal oxides, as well as physical mixtures, chemical combinations and/or atomically-doped combinations thereof.

As used herein, the terms of “NOx adsorbed catalyst” and “NOx trap (also called Lean NOx trap, abbr. LNT)” refer to catalysts for reducing oxides of nitrogen (NO and NO₂) emissions from a lean burn internal combustion engine by means of adsorption. Typical NOx trap includes alkaline earth metal oxides, such as oxides of Mg, Ca, Sr and Ba, alkali metal oxides such as oxides of Li, Na, K, Rb and Cs, and rare earth metal oxides such as oxides of Ce, La, Pr and Nd in combination with precious metal catalysts such as platinum dispersed on an alumina support have been used in the purification of exhaust gas from an internal combustion engine. For NOx storage, baria is usually preferred because it forms nitrates at lean engine operation and releases the nitrates relatively easily under rich conditions.

In an embodiment, the first catalytic layer is a washcoat. The details of the washcoat can refer to the above description for “washcoat”.

In an embodiment, the first catalytic layer is formed from the first composition.

In an embodiment, first catalytic layer extends from upstream end of the PF. In an embodiment, the first catalytic layer extends from downstream end of the PF.

### The Second Catalytic Layer

According to the present invention, the catalyzed particulate filter of the present invention further comprises a second catalytic layer coated onto the particulate filter, wherein the second catalytic layer comprises a second composition, and wherein the second composition comprises a second support material.

According to the present invention, the second support material comprises at least one inorganic material, preferably, the inorganic material is selected from inorganic oxide and inorganic salt.

The inorganic material and inorganic salt can be selected from alumina, zirconia, ceria, silica, titania, magnesium oxide, zinc oxide, manganese oxide, calcium oxide, silicate zeolite, alumino silicate zeolite, a rare earth metal oxide other than ceria, a mixed oxide comprising two or more of Al, Zr, Ti, Si, and Ce, cerium zirconium mixed oxide, hydrated alumina, calcium carbonate, calcium sulfate, barium sulfate and zinc carbonate, preferably alumina, such as gamma alumina.

According to the present invention, the second composition is in the form of particulate. In one embodiment, the second composition has a D90 of 0.1 to 50 μm, for example 0.2, 0.5, 0.8, 1, 1.5, 2, 3, 4, 5, 6, 7, 8, 9, 10, 12, 15, 18, 20, 25, 30, 35, 40, 45 μm, preferably 1 to 20 μm, and more preferably a D90 of 3 to 10 μm, for example 4, 5, 6, 7, 8, or 9 μm. In one embodiment, the second composition has a D50 of 1.2 to 8 μm, preferably 1.8 to 6 μm, for example, 2, 3, 4 or 5 μm. In one embodiment, the second composition has a D10 of 0.4 to 2.2 μm, preferably 0.6 to 1.5 μm.

“D90”, “D50” and “D10” have their usual meaning of referring to the point where the cumulative weight from the small-particle-diameter side reaches 90%, 50% and 10% in the cumulative particle size distribution. D90 is the value determined by measuring the particle size distribution, respectively. The particle size distribution is measured by using laser diffraction particle size distribution analyzer.

In one embodiment, the second support material has high specific BET surface area, for example in the range from 100 to 250 m²/g, preferably in the range from 120 to 200 m²/g characterized by 77K nitrogen sorption. In a preferred embodiment, the inorganic material has a specific surface area characterized by 77K nitrogen sorption in the range from 50 to 120 m²·g⁻¹, preferably 60 to 95 m²/g after 4 h calcination in air at 1000° C.

In one embodiment, the second composition further comprises a platinum group metal (PGM), preferably selected from the group consisting of platinum (Pt), palladium (Pd) and rhodium (Rh), and mixtures thereof. The PGM is present in a catalytically effective amount to convert NOx, CO and hydrocarbons in an exhaust gas to N₂, CO₂ and H₂O and to cause the oxidation of particulate matter trapped on the particulate filter. In a preferred embodiment, the second composition comprises a PGM containing inorganic material. The PGM containing inorganic material can be prepared by impregnating the inorganic material with a PGM containing liquid, for example an amine-complex solution or solution of the nitrate of PGM (for example platinum nitrate, palladium nitrate, and rhodium nitrate). After the impregnation, the mixture can be calcinated.

In an embodiment, the second catalytic layer and the second composition does not comprise a platinum group metal.

The ratio of the weight of the second catalytic layer to the total volume of the PF can be in the range from 0.5 to 20 g/L, for example 0.6 g/L, 0.7 g/L, 0.8 g/L, 0.9 g/L, 1.0 g/L, 2.0 g/L, 5 g/L, 8 g/L, 10 g/L, 12 g/L, 15 g/L, 18 g/L, or 20 g/L, preferably from 0.6 to 15 g/L, more preferably from 0.7 to 12 g/L.

According to the present invention, the second catalytic layer is present on the whole length L of the PF. According to the present invention, the second catalytic layer can be present on the inlet channels.

According to the present invention, the second catalytic layer can be coated via a gas carrier. The details of the coating via a gas carrier can refer to the following description for step (iii) in the process for preparing the catalyzed particulate filter of the present invention.

In an embodiment, the second catalytic layer is formed from the second composition.

### Process for Preparing the Catalyzed Particulate Filter and Use of PF

Another aspect of the present invention relates to a process for preparing the catalyzed particulate filter according to the present invention, comprises:
i) providing a filter substrate of total length L;
ii) coating the filter substrate with a slurry containing the first composition from either the upstream end or the downstream end of the particulate filter; and
iii) further coating the filter substrate obtained in step ii) with the second composition.
   wherein the length (L1) of the portion of the filter substrate coated with the first composition is in the range from 20 to 90% of L.

The slurry in step ii) can be formed by mixing a liquid medium (such as water) with the platinum group metal (PGM) component and refractory metal oxide and if present OSC and dopant. In a preferred embodiment, the PGM component (e.g., in the form of a solution of a PGM salt) can be impregnated onto a refractory metal oxide support (e.g., as a powder) by, for example, incipient wetness techniques to obtain a wet powder. Water-soluble PGM compounds or salts or water-dispersible compounds or complexes of the PGM component may be used as long as the liquid medium used to impregnate or deposit the metal component onto the support particles does not adversely react with the metal or its compound or its complex or other components which may be present in the catalyst composition and is capable of being removed by volatilization or decomposition upon heating and/or application of a vacuum. Generally, both from the point of view of economics and environmental aspects, aqueous solutions of soluble compounds, salts, or complexes of the PGM component are advantageously utilized. In some embodiments, the PGM component are loaded onto the support by the co-impregnation method. The co-impregnation technique is known to those skilled in the art and is disclosed in, for example, U.S. Pat. No. 7,943,548, which is incorporated by reference herein for the relevant teachings. The wet powder can be mixed with the liquid medium such as water to form the slurry.

The slurry can be milled to enhance mixing of the particles and formation of a homogenous material. The milling can be accomplished in a ball mill, continuous mill, or other similar equipment, and the solids content of the slurry may be, e.g., about 20 to 60 wt. %, more particularly about 30 to 40 wt. %. In one embodiment, the post-milling slurry is characterized by a D90 particle size of about 1 to about 30 microns. The D90 is defined as the particle size at which 90% of the particles have a finer particle size.

The slurry was then coated onto the particulate filter from either upstream or downstream end of PF using deposition methods, which is known in the art.

After coating with the slurry, the filter substrate can be dried. Most of the water in the slurry can be removed by drying so as to reduce the amount of moisture produced during the subsequent calcination. Conventional drying methods include drying at elevated temperature (for example at 100 to 200° C. for 1 min to 2 h) or drying by microwave. The input power of microwave drying can be between 1 kW and 12 KW, and the duration can be between 5 min and 2 hr.

Then, the filter substrate is generally calcined. An exemplary calcination process involves heat treatment in air at a temperature of about 400 to about 700° C. for about 10 minutes to about 3 hours. During the calcination step, the PGM component is converted into a catalytically active form of the metal or metal oxide thereof. The above process can be repeated as needed.

Step (iii) can be carried out by coating the filter substrate obtained in step (ii) with the second composition in a particulate form via a gas carrier through one side of the filter substrate.

The second composition can be coated onto the inlet channels.

After coating with the second composition, the filter substrate can be dried and/or calcinated, for example dried at 120 to 200° C., and/or calcinated at 350 to 550° C. for 30 min to 3 h.

A further aspect of the present invention relates to a method for the treatment of exhaust gas from an internal combustion engine, which comprises flowing the exhaust gas from the engine through the particulate filter according to the present invention or prepared by the process according to the present invention. The exhaust gas comprises unburned hydrocarbons, carbon monoxide, nitrogen oxides, and particulate matter.

### EXAMPLES

The present invention is further illustrated by the following examples, which are set forth to illustrate the present invention and is not to be construed as limiting thereof. Unless otherwise noted, all parts and percentages are by weight, and all weight percentages are expressed on a dry basis, meaning excluding water content, unless otherwise indicated. In each of the examples, the filter substrate was made of cordierite.

### Example 1—Comparative

The catalyzed particulate filter of Example 1 was prepared using double coats: a first catalytic layer coated from upstream end, extending in axial direction for the full length of the filter substrate; and a second catalytic layer coated from upstream end of the wall-flow filter substrate. The wall-flow filter substrate had a size of 118.4 mm (D)*127 mm (L), a volume of 1.4 L, a cell density of 300 cells per square inch, a wall thickness of approximately 200 μm, a porosity of 65% and a mean pore size of 17 μm in diameter by mercury intrusion measurements.

The first catalytic layer contained a three-way conversion (TWC) catalyst composite with a PGM loading of 20 g/ft³ (0.71 g/L, Pd/Rh=3/1). The Pd/Rh containing catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above wet powders into water, followed by the addition of barium hydroxide and zirconium nitrate solution. The slurry was then milled to a particle size of 90% being 5 μm. The slurry was then coated from the upstream end of the wall-flow filter substrate and covering the total substrate length. After coating, the filter substrate plus the washcoat were dried at 150° C. and then calcined at a temperature of 550° C. for about 1 hour. The calcined Pd/Rh catalytic layer was having 68.4 wt. % ceria-zirconia composite, 0.70 wt. % palladium, 0.23 wt. % rhodium, 4.6 wt. % of barium oxide, 1.4 wt. % zirconia oxide with the balance being alumina. The total loading of the first catalytic layer was 1.24 g/in³ (75.67 g/L).

The second catalytic layer was a high surface area alumina powder (about 150 m²/g). This powder had a particle size distribution of 90% being 5 μm, 50% being 2 μm, and 10% bing 0.8 μm, and a specific surface area (BET model, 77K nitrogen adsorption measurement) of 66 m²/g after 4 hr calcination in air at 1000° C. This powder was mixed with gas carrier and blown-in into the filter substrate from upstream end at room temperature. The flow rate of gas carrier was 500 kg/hr. The loading of the second catalytic layer was 0.115 g/in³ (7.02 g/L).

### Example 2

The catalyzed particulate filter of Example 2 was prepared using double coats: a first catalytic layer coated from upstream end, extending in axial direction for 50% of the length of the filter substrate; and a second catalytic layer coated from upstream end of the wall-flow filter substrate. The wall-flow filter substrate had a size of 118.4 mm (D)*127 mm (L), a volume of 1.4 L, a cell density of 300 cells per square inch, a wall thickness of approximately 200 μm, a porosity of 65% and a mean pore size of 17 μm in diameter by mercury intrusion measurements.

The first catalytic layer contained a three-way conversion (TWC) catalyst composite with a PGM loading of 40 g/ft³ (Pd/Rh=3/1, 1.41 g/L) for the coated area. The Pd/Rh containing catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above wet powders into water, followed by the addition of barium hydroxide and zirconium nitrate solution. The slurry was then milled to a particle size of 90% being 5 μm. The slurry was then coated from the upstream end of the wall-flow filter substrate and covering 50% of the total length of the filter substrate. After coating, the filter substrate plus the washcoat were dried at 150° C. and then calcined at a temperature of 550° C. for about 1 hour. The calcined Pd/Rh catalytic layer was having 68.0 wt. % ceria-zirconia composite, 1.16 wt. % palladium, 0.39 wt. % rhodium, 4.5 wt. % of barium oxide, 1.4 wt. % zirconia oxide with the balance being alumina. The total loading of the first catalytic layer was 1.50 g/in³ (91.54 g/L) for the coated area.

The second catalytic layer was a high surface area alumina powder (about 150 m²/g). This powder had a particle size distribution of 90% being 5 μm, 50% being 2 μm, and 10% being 0.8 μm, and a specific surface area (BET model, 77K nitrogen adsorption measurement) of 66 m²/g after 4 hr calcination in air at 1000° C. This powder was mixed with gas carrier and blown-in into the filter substrate from upstream end at room temperature. The flow rate of gas carrier was 500 kg/hr. The loading of the second catalytic layer was 0.0574 g/in³ (3.50 g/L).

### Example 3—Comparative

The catalyzed particulate filter of Example 3 was prepared in a similar way as Example 1, except that the total loading of the first catalytic layer was 0.74 g/in³ (45.16 g/L); the PGM loading of the first catalytic layer was 6 g/ft³ (Pd/Rh=1/1, 0.21 g/L); and the loading of the second catalytic layer was 0.0164 g/in³ (1.00 g/L).

### Example 4

The catalyzed particulate filter of Example 4 was prepared using double coats: a first catalytic layer coated from upstream end, extending in axial direction for 75% of the length of the filter substrate; and a second catalytic layer coated from upstream end of the wall-flow filter substrate. The wall-flow filter substrate had a size of 118.4 mm (D)*127 mm (L), a volume of 1.4 L, a cell density of 300 cells per square inch, a wall thickness of approximately 200 μm, a porosity of 65% and a mean pore size of 17 μm in diameter by mercury intrusion measurements.

The first catalytic layer contained a three-way conversion (TWC) catalyst composite with a PGM loading of 8 g/ft³ (Pd/Rh=1/1, 0.28 g/L) for the coated area. The Pd/Rh containing catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above wet powders into water, followed by the addition of barium hydroxide and zirconium nitrate solution. The slurry was then milled to a particle size of 90% being 5 μm. The slurry was then coated from the upstream end of the wall-flow filter substrate and covering 75% of the total length of the filter substrate. After coating, the filter substrate plus the washcoat were dried at 150° C. and then calcined at a temperature of 550° C. for about 1 hour. The calcined Pd/Rh catalytic layer was having 68.7 wt. % ceria-zirconia composite, 0.23 wt. % palladium, 0.23 wt. % rhodium, 4.6 wt. % of barium oxide, 1.4 wt. % zirconia oxide with the balance being alumina. The total loading of the first catalytic layer was 0.99 g/in³ (60.41 g/L) for the coated area.

The second catalytic layer was a high surface area alumina powder (about 150 m²/g). This powder had a particle size distribution of 90% being 5 μm, 50% being 2 μm, and 10% being 0.8 μm, and a specific surface area (BET model, 77K nitrogen adsorption measurement) of 66 m²/g after 4 hr calcination in air at 1000° C. This powder was mixed with gas carrier and blown-in into the filter substrate from upstream end at room temperature. The flow rate of gas carrier was 500 kg/hr. The loading of the second catalytic layer was 0.0164 g/in³ (1.00 g/L).

### Example 5

The catalyzed particulate filter of Example 5 was prepared in a similar way as Example 2, except that the total loading of the first catalytic layer was 1.48 g/in³ (90.32 g/L) for the coated area (in axial direction for 50% of the length of the filter substrate); the PGM loading of the first catalytic layer was 12 g/ft³ (Pd/Rh=1/1, 0.42 g/L) for the coated area; and the loading of the second catalytic layer was 0.0164 g/in³ (1.00 g/L).

### Example 6

The catalyzed particulate filter of Example 6 was prepared using double coats: a first catalytic layer coated from upstream end, extending in axial direction for 33% of the length of the filter substrate; and a second catalytic layer coated from upstream end of the wall-flow filter substrate. The wall-flow filter substrate had a size of 118.4 mm (D)*127 mm (L), a volume of 1.4 L, a cell density of 300 cells per square inch, a wall thickness of approximately 200 μm, a porosity of 65% and a mean pore size of 17 μm in diameter by mercury intrusion measurements.

The first catalytic layer contained a three-way conversion (TWC) catalyst composite with a PGM loading of 18 g/ft³ (Pd/Rh=1/1, 0.64 g/L) for the coated area. The Pd/Rh containing catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above wet powders into water, followed by the addition of barium hydroxide and zirconium nitrate solution. The slurry was then milled to a particle size of 90% being 5 μm. The slurry was then coated from the upstream end of the wall-flow filter substrate and covering 33% of the total length of the filter substrate. After coating, the filter substrate plus the washcoat were dried at 150° C. and then calcined at a temperature of 550° C. for about 1 hour. The calcined Pd/Rh catalytic layer was having 68.7 wt. % ceria-zirconia composite, 0.23 wt. % palladium, 0.23 wt. % rhodium, 4.6 wt. % of barium oxide, 1.4 wt. % zirconia oxide with the balance being alumina. The total loading of the first catalytic layer was 2.22 g/in³ (135.47 g/L) for the coated area.

The second catalytic layer was a high surface area alumina powder (about 150 m²/g). This powder had a particle size distribution of 90% being 5 μm, 50% being 2 μm, and 10% being 0.8 μm, and a specific surface area (BET model, 77K nitrogen adsorption measurement) of 66 m²/g after 4 hr calcination in air at 1000° C. This powder was mixed with gas carrier and blown-in into the filter substrate from upstream end at room temperature. The flow rate of gas carrier was 500 kg/hr. The loading of the second catalytic layer was 0.0164 g/in³ (1.00 g/L).

### Example 7—Comparative

The catalyzed particulate filter of Example 7 was prepared in a similar way as Example 3, except that the loading of the second catalytic layer was 0.115 g/in³ (7.02 g/L).

### Example 8

The catalyzed particulate filter of Example 8 was prepared in a similar way as Example 4, except that the loading of the second catalytic layer was 0.111 g/in³ (6.77 g/L).

### Example 9

The catalyzed particulate filter of Example 9 was prepared in a similar way as Example 5, except that the loading of the second catalytic layer was 0.106 g/in³ (6.47 g/L).

### Example 10

The catalyzed particulate filter of Example 10 was prepared using double coats: a first catalytic layer coated from downstream end, extending in axial direction for 50% of the length of the filter substrate; and a second catalytic layer coated from upstream end of the wall-flow filter substrate. The wall-flow filter substrate had a size of 118.4 mm (D)*127 mm (L), a volume of 1.4 L, a cell density of 300 cells per square inch, a wall thickness of approximately 200 μm, a porosity of 65% and a mean pore size of 17 μm in diameter by mercury intrusion measurements.

The first catalytic layer contained a three-way conversion (TWC) catalyst composite with a PGM loading of 12 g/ft³ (Pd/Rh=1/1, 0.42 g/L) for the coated area. The Pd/Rh containing catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above powders into water, followed by the addition of barium hydroxide and zirconium nitrate solution. The slurry was then milled to a particle size of 90% being 5 μm. The slurry was then coated from the downstream end of the wall-flow filter substrate and covering 50% of the total length of the filter substrate. After coating, the filter substrate plus the washcoat were dried at 150° C. and then calcined at a temperature of 550° C. for about 1 hour. The calcined Pd/Rh catalytic layer was having 68.7 wt. % ceria-zirconia composite, 0.23 wt. % palladium, 0.23 wt. % rhodium, 4.6 wt. % of barium oxide, 1.4 wt. % zirconia oxide with the balance being alumina. The total loading of the first catalytic layer was 2.22 g/in³ (135.47 g/L) for the coated area.

The second catalytic layer was a high surface area alumina powder (about 150 m²/g). This powder had a particle size distribution of 90% being 5 μm, 50% being 2 μm, and 10% being 0.8 μm, and a specific surface area (BET model, 77K nitrogen adsorption measurement) of 66 m²/g after 4 hr calcination in air at 1000° C. This powder was mixed with gas carrier and blown-in into the filter substrate from upstream end at room temperature. The flow rate of gas carrier was 500 kg/hr. The loading of the second catalytic layer was 0.106 g/in³ (6.47 g/L).

### Example 11—Testing of Filtration Efficiency and Backpressure of Catalyzed Particulate Filter

Both the filtration efficiencies and the backpressure of above examples at fresh state (0 km, or out-of-box state) were measured on an engine bench. The samples were installed downstream of a 2.0 L turbocharged inline-four engine, which was running at stationary state with exhaust flow rate of 300 kg/h and exhaust temperature of 830° C. The concentration of particulate matters was about 10⁶/cc.

Particulate matter emissions and pressure-drops were monitored at both the upstream and downstream of the samples, and data collected were used to calculate the filtration efficiency and backpressure of the samples:

$$Filtration Efficiency = 1 - ( PN downstream / PN upstream ) \times 100 \%$$

$$Backpressure = dP upstream - dP downstream$$

wherein
PN downstream is the number of particulate matters measured downstream of the filter;
PN upstream is the number of particulate matters measured upstream of the filter;
dP upstream is the pressure drop measured upstream of the filter;
dP downstream is the pressure drop measured upstream of the filter.

### The Catalyzed Particulate Filters of Examples 1 & 2

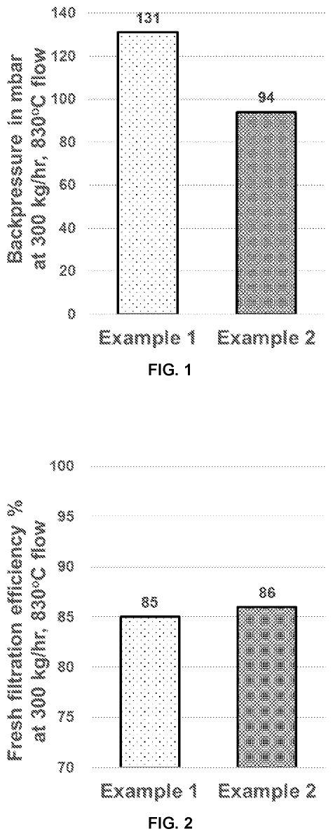

As shown in FIG. 1 and FIG. 2, despite of significantly lower amount (−50%) of second catalytic layer applied, Example 2 was able to show comparable filtration efficiency to comparative Example 1, but with a favorable much lower backpressure.

### The Catalyzed Particulate Filters of Examples 3 to 6

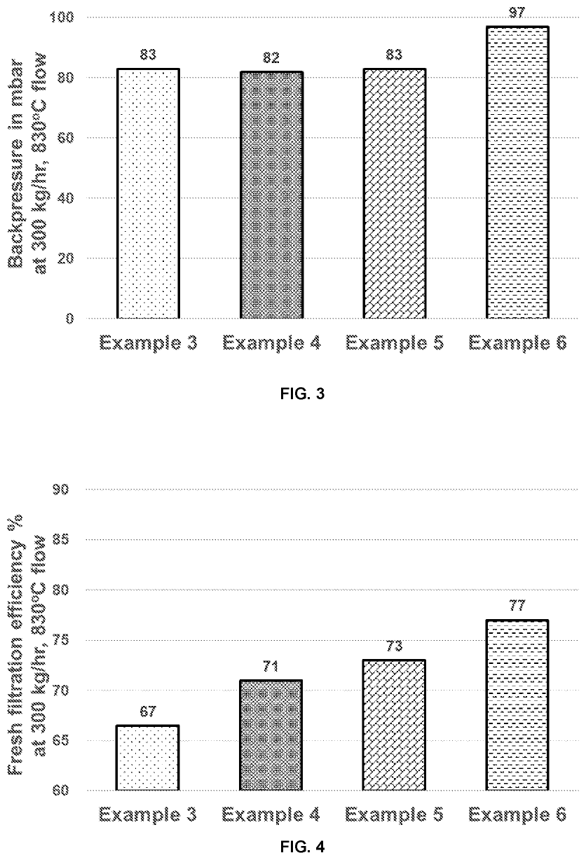

As exhibited in FIG. 3, with the same universal washcoat loading of the first catalytic layer and the same material loading of the second catalytic layer, which was blown-in with gas carrier, Example 6, with the shortest coated length of the first catalytic layer, showed approximately 5% higher backpressure than Examples 3, 4 and 5, whose backpressures were measured similar under the described condition.

Interestingly, as indicated in FIG. 4, the fresh filtration efficiencies of these samples were reversely proportional to the coated length of the first catalytic layer of the samples, i.e. the filtration efficiency increased from 67% for comparative Example 3, to 71% for Example 4, to 73% for Example 5, and to 77% for Example 6; while the coating length of the first catalytic layer decreased from 100% of the total substrate length in comparative Example 3, to 75% in Example 4, to 50% in Example 5, and to 33% in Example 6.

### The Catalyzed Particulate Filters of Examples 7 to 10

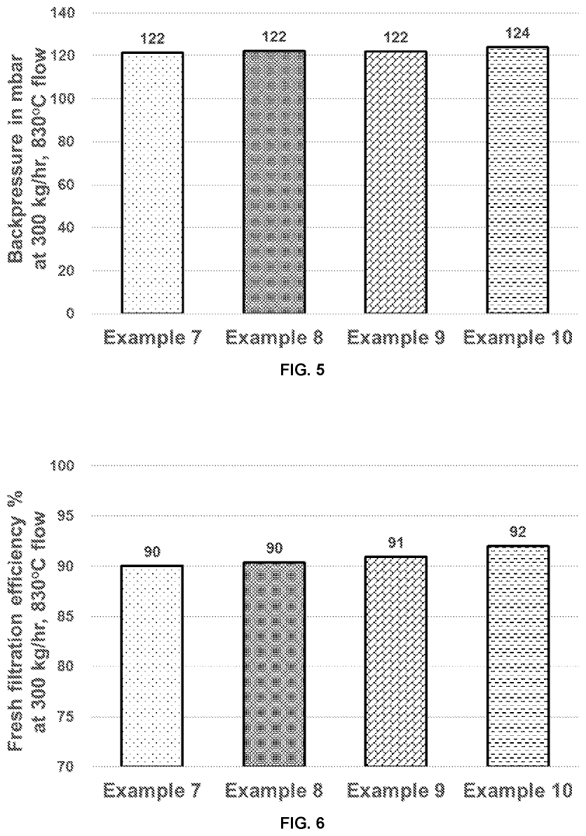

As exhibited in FIGS. 5 & 6, even though smaller amount of second catalytic layer was applied in Examples 8 to 10, they demonstrated equal to better filtration efficiency as compared to comparative Example 7, with almost no backpressure penalty.

1. A catalyzed particulate filter for exhaust gas from an internal combustion engine, comprising:
a particulate filter (PF) of total length L;
a first catalytic layer coated onto the particulate filter, comprising a first composition, wherein the first composition comprising a first support material; and a first platinum group metal (PGM) and/or a first catalytic active transitional metal;
a second catalytic layer coated onto the particulate filter, comprising a second composition, wherein the second composition comprises a second support material; and
said first catalytic layer is present on a portion of said PF, and extends from either upstream or downstream end in axial direction of said PF for a length (L1), and L1 is in the range from 20 to 90% of L.

2. The catalyzed particulate filter according to claim 1, wherein L1 is in the range from 25% to 85% of L, preferably from 28% to 80% of L.

3. The catalyzed particulate filter according to claim 1, wherein the ratio of the weight of the first catalytic layer to the volume of the portion of the PF coated with the first catalytic layer is in the range from 10 to 160 g/L, preferably from 15 to 150 g/L or from 20 to 120 g/L.

4. The catalyzed particulate filter according to claim 1, wherein the ratio of the weight of the first catalytic layer to the total volume of the PF is in the range from 10 to 120 g/L, preferably from 20 to 100 g/L.

5. The catalyzed particulate filter according to claim 1, wherein the first support material comprises at least one refractory metal oxide.

6. The catalyzed particulate filter according to claim 1, wherein the first catalytic layer is a washcoat.

7. The catalyzed particulate filter according to claim 1, wherein the first catalytic active transitional metal is selected from Cu, Fe, Co, Ni, La, Ce, Ag or Mn, or any combination thereof, preferably selected from Ce, Mn, Cu or Fe, or any combination thereof.

8. The catalyzed particulate filter according to claim 1, wherein the second support material comprises at least one inorganic material, preferably, the inorganic material is selected from inorganic oxide and inorganic salt.

9. The catalyzed particulate filter according to claim 1, wherein the second composition is in the form of particulate, preferably the second composition has a D90 of 0.1 to 50 μm, preferably 1 to 20 μm, and more preferably a D90 of 3 to 10 μm.

10. The catalyzed particulate filter according to claim 1, wherein the ratio of the weight of the second catalytic layer to the total volume of the PF is in the range from 0.5 to 20 g/L, preferably from 0.6 to 15 g/L, more preferably from 0.7 to 12 g/L.

11. The catalyzed particulate filter according to claim 1, wherein the second catalytic layer is present on the whole length L of the PF.

12. The catalyzed particulate filter according to claim 1, wherein said first catalytic layer extends from upstream end of the PF.

13. The catalyzed particulate filter according to claim 1, wherein said first catalytic layer extends from downstream end of the PF.

14. A process for preparing the catalyzed particulate filter according to claim 1, comprising:
i) providing a filter substrate of total length L;
ii) coating the filter substrate with a slurry containing the first composition from either the up-stream end or the downstream end of the particulate filter; and
iii) further coating the filter substrate obtained in step ii) with the second composition;
wherein the length (L1) of the portion of the filter substrate coated with the first composition is in the range from 20 to 90% of L.

15. The process according to claim 14, wherein step (iii) is carried out by coating the filter substrate obtained in step (ii) with the second composition in a particulate form via a gas carrier through one side of the filter substrate.

16. The process according to claim 14, wherein step (ii) further comprises calcinating the coated filter substrate after coating.

17. A method for the treatment of exhaust gas from an internal combustion engine, which comprises flowing the exhaust gas from the engine through the catalyzed particulate filter according to claim 1.

18. The method according to claim 17, wherein the exhaust gas comprises unburned hydrocarbons, carbon monoxide, nitrogen oxides, and particulate matter.

19. The process according to claim 15, wherein step (ii) further comprises calcinating the coated filter substrate after coating.
